(19) United States
(12) Patent Application Publication
(10) Pub. No.: US 2011/0095598 A1
(43) Pub. Date: Apr. 28, 2011

(54) Skateboard wheel cover

(75) Inventors: Michael Joseph Hooven, Lake Oswego, OR (US); Michael Joseph Caulk, Wilsonville, OR (US)

(73) Assignee: C Note, Inc.

(21) Appl. No.: 12/653,008

(22) Filed: Dec. 7, 2009

Related U.S. Application Data
(60) Provisional application No. 61/254,120, filed on Oct. 22, 2009.

(51) Int. Cl. B60B 27/06

(52) U.S. Cl. 301/108.5

(57) ABSTRACT

A wheel cover for a skate board is securable to a tubular bearing sleeve inserted in the central aperture of a skate board tire.

### CROSS-REFERENCE TO RELATED APPLICATIONS

This application claims the benefit of U.S. Provisional Application No. 61/254,120, filed Oct. 22, 2009.

### BACKGROUND OF THE INVENTION

The present invention relates to a wheel cover for a wheel of a skateboard.

Referring to FIG. 1, a skateboard 20 comprises, generally, a deck 22 on which the rider stands and which is supported by two pairs of wheels 24, 26; one pair proximate each end of the deck. Each pair of wheels is attached to the deck by a truck 28 comprising an upper portion 30 which is, typically, attached to the bottom of the deck with screws and a lower portion 32 that includes an elongate axle 34. The upper and lower portions are typically metal and are usually separated by a resilient bushing 36 enabling articulation between the upper and lower portions of the truck so that the deck can be tilted relative to the axle to facilitate turning the skateboard. A wheel 40 is mounted on each end of the axle and typically comprises an annular, molded plastic tire having an outer diameter, inner and outer sidewalls, and a central aperture extending between the sidewalls. The tire is rotatably supported on the axle by a pair of wheel bearings having an outer race that fits snuggly in the central aperture of the tire. An inner bearing is located proximate the inner sidewall, the sidewall nearest the centerline of the deck, and an outer bearing is located proximate the outer sidewall of the tire. A wheel nut 38 in threaded engagement with the axle secures the wheel bearings and the tire to the axle. Typically, the securing nut, the end of the axle and a portion of the outer bearing are visible in the center of the wheel. The outer bearing is exposed to moisture, sand, dirt and other contaminants which can reduce the bearing's life and increase friction in the bearing. The sidewalls of tires are often decorated to enhance the cosmetic appearance of the tire or advertise the wheel's manufacturer and its products. Skateboarders commonly decorate the decks of their boards as a matter of personal expression. Decorative wheel covers are available for skateboard wheels. These wheel covers can hide the wheel nut, the end of the axle and/or a portion of the wheel's sidewall.

Caplin, U.S. Pat. No. 4,962,968 discloses a hubcap for a skateboard wheel that conceals the wheel nut and the end of the axle and shields the outer wheel bearing from environmental contamination. The hubcap includes a hollow column portion that is pushed over the outer surface of the wheel nut and which is secured to the wheel nut by a detent. The column portion supports a shield portion which is of sufficient diameter to conceal the wheel nut and the exposed portion of the outer bearing. The shield provides a barrier against the entry of environmental contamination into the vicinity of the bearing and can be decorated to enhance its appearance. However, the visual impact of the decoration is limited because the shield is stationary and the required clearance between the stationary shield and the moving sidewall of the tire provides a potential entry path for contamination.

Martin, U.S. Pat. No. 6,454,361 B1, discloses a removable decorative wheel cover that is disposed within a cavity in the sidewall of the tire that is either molded into the tire when it is manufactured or machined into the finished tire. The wheel cover attached to the tire with screws that engage threaded metal inserts that are pressed into pilot holes in the end wall of the recessed cavity. The wheel cover is an annular ring with a central aperture that is large enough to permit the removal of the wheel bearing and the nut which secures the wheel to the axle so the wheel mounting hardware is visible and the wheel bearing is exposed to contaminants through the large central opening in the decorative cover. In addition, the threaded inserts spaced around the specially manufactured or modified tire can cause local inconsistency in the compressibility of the wheel resulting in vibration.

What is desired, therefore, is a decorative wheel cover for a skateboard wheel that hides the end of the axle and the wheel nut, protects the wheel bearing from contamination, and which is easily removed to facilitate servicing the wheel and bearings.

### BRIEF DESCRIPTION OF THE DRAWINGS

FIG. 1 is perspective view of a skateboard.

FIG. 2 is a cutaway view of a skateboard wheel and wheel cover.

FIG. 3A is an end view of a bearing sleeve.

FIG. 3B is an elevation view of the bearing sleeve of FIG. 3A.

FIG. 3C is an end view of a second end of the bearing sleeve of FIG. 3A.

FIG. 3D is a section view of the bearing sleeve of FIG. 3A along line D-D.

FIG. 4 is a section view of a skateboard wheel and an additional embodiment of a wheel cover.

FIG. 5A is an end view of a second embodiment of a bearing sleeve.

FIG. 5B is a section view of the bearing sleeve of FIG. 5A along line B-B.

FIG. 6 is a partial section view of a wheel cover with alternate securement.

FIG. 7 is a partial elevation view of a wheel cover with a second alternate securement.

FIG. 8A is an end view of a wheel cover with decorative facets.

FIG. 8B is an elevation view of the wheel cover with decorative facets of FIG. 8A.

FIG. 9 illustrates use of a wheel cover as a supporting surface for a skateboard.

### DETAILED DESCRIPTION OF PREFERRED EMBODIMENTS

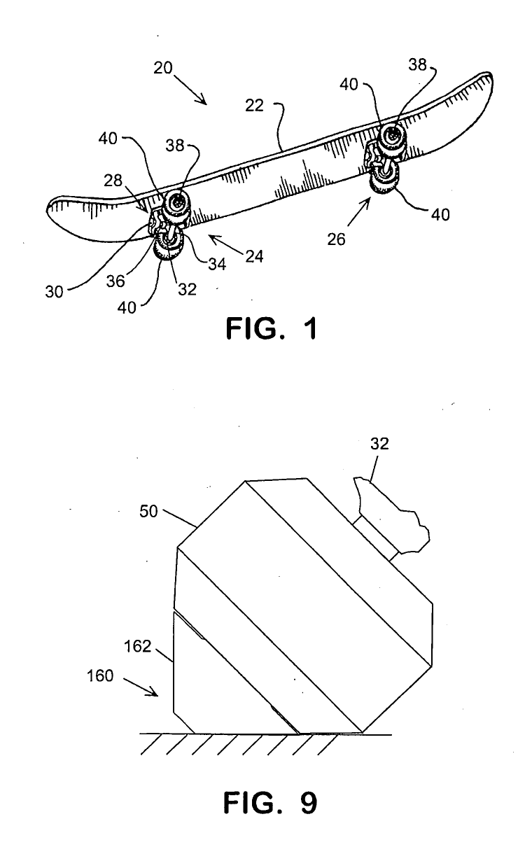

Referring in detail to the drawings where similar parts are identified by like reference numerals, and, more particularly to FIG. 1, a skateboard 20 typically comprises a deck 22 on which the rider stands and which is supported by two pairs of wheels 24, 26; one pair proximate each end of the deck. Each pair of wheels is attached to the deck by a truck 28 comprising an upper portion 30 which is, typically, attached to the bottom of the deck with screws and a lower portion 32 that includes an elongate axle 34. The upper and lower portions are typically metal and are usually separated by a resilient bushing 36 that enables articulation between the upper and lower portions of the truck so that the deck can be tilted relative to the axle to facilitate turning the skateboard. A wheel 40 is mounted at each end of the axle.

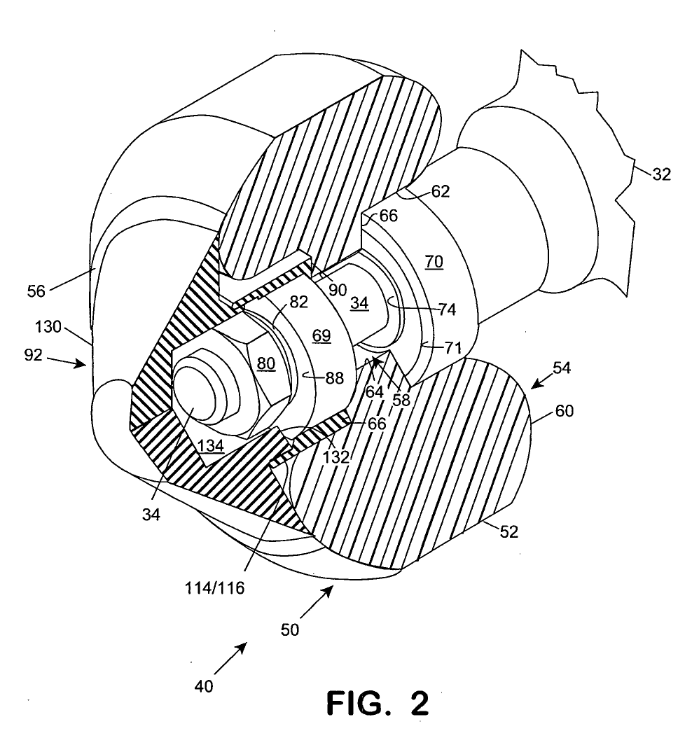

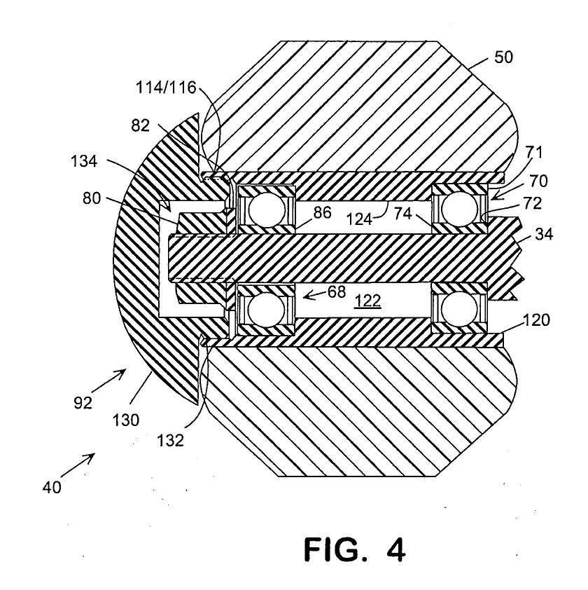

Referring also to FIGS. 2 and 4, a skateboard wheel 40 typically comprises an annular, molded plastic tire 50 having an outer diameter 52; an inner sidewall 54, proximate the longitudinal centerline of the deck; an outer sidewall 56, more distal of the center of deck than the inner sidewall; and a central aperture 58. Typically, a substantial radius 60 defines the intersecting planes of the sidewalls and the outer circumferential surface of the tire. A thermoplastic, such as polyurethane, is commonly the material of choice for skateboard tires. The tire typically has a central aperture 58 that is concentric to the outer diameter of the tire and which may be either molded during the manufacture of the tire or machined into a tire blank. The aperture is typically stepped with a larger diameter portion 62 proximate each sidewall and a central portion 64 having a smaller diameter. The tire is typically supported on the axle by two bearings 68, 70 which are inserted into the larger diameter portions of the central aperture proximate each of end of the elongate aperture. The outer diameter of the bearing's outer race is sized to closely fit the larger diameter portions of the aperture in the tire. The transition from the larger diameter portions 62 of the aperture proximate the sidewalls of the tire to the smaller diameter central portion 64 of the aperture provides a circular shoulder 66, 67 around the wall of the aperture to contact the side of the bearing's outer race 71 and control the lateral position of the bearing in the bore. A shoulder 72 on the axle bears against the sidewall of the inner race 74 of the inner bearing 70. A nut 80, typically self-locking, is threaded on to the axle and may bear on a washer 82 which, in turn, bears against the sidewall of the inner race 86 of the outer bearing 68, 69 securing the wheel to the axle.

Typically, the wheel nut 80, the end of the axle 34 and the outer sidewall of the outer bearing 68 are exposed when the wheel is attached to the axle. For aesthetic reasons, many skateboarders prefer that the exposed portions of the wheel attaching hardware be covered. In addition, skateboards are commonly used outdoors on sidewalks and roads. Environmental contaminants, including dirt, sand and water, can enter the wheel bearings causing increased friction, wear and premature failure. Moreover, longboards are commonly ridden for relatively long distances on streets and the extended periods of operation can cause heat to buildup in the tires and bearings. The present inventors concluded that a wheel cover could be used to conceal the wheel attaching hardware, protect the outer bearing from contamination and dissipate heat generated in the wheel.

The wheel cover comprises generally a bearing sleeve 90 and a cover 92 removably securable to the bearing sleeve. The bearing sleeve is generally tubular with an internal diameter that closely fits the outer diameter of the wheel bearings and an outside diameter that closely fits a portion of the central aperture of the tire. The bearing sleeve is pressed into the tire and may also be secured in the tire by adhesive or otherwise.

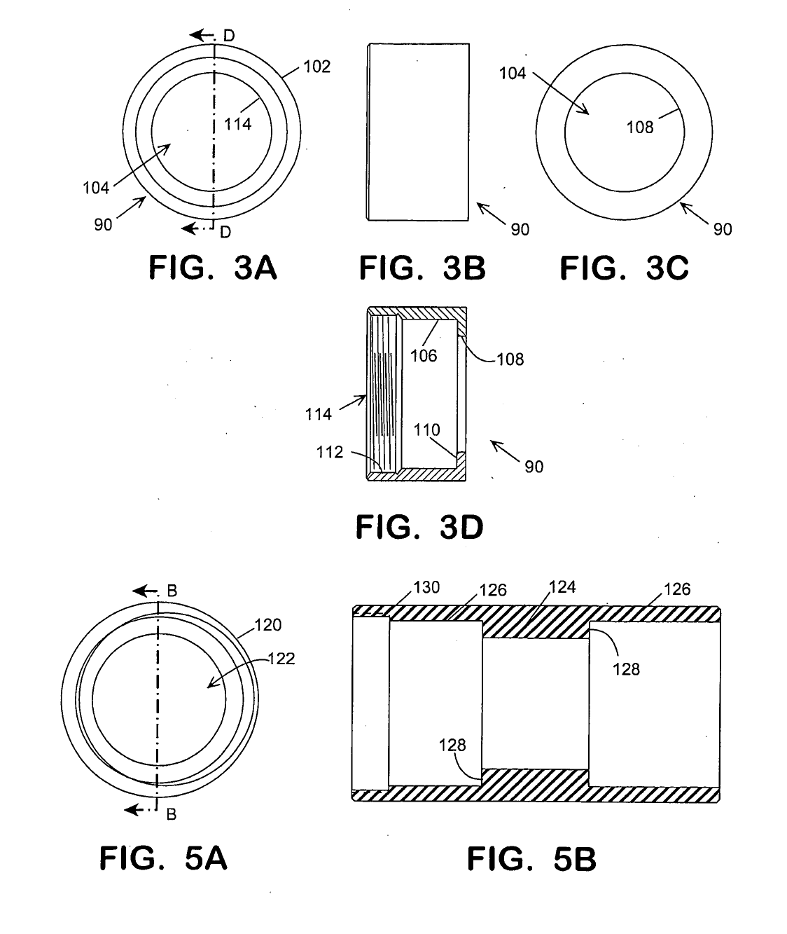

Referring to also FIG. 3A-3D, in a preferred embodiment that is particularly useful when installing a wheel cover on an existing wheel, the bearing sleeve has an outer diameter 102 that closely fits the diameter of the portion of the central aperture of the tire that normally engages the outer race 88 of the outer wheel bearing 69. The bearing sleeve is inserted into the central aperture in the tire in the position normally occupied by the outside wheel bearing and the end of the bearing sleeve distal of the tire's sidewall engages the shoulder 67 in the central aperture of the tire that normally bears against the outer race of the wheel bearing.

The wall of the bearing sleeve defines an elongate central aperture 104 extending the length of the bearing sleeve. The length of the central aperture of the bearing sleeve is divided into three portions. A central length portion 106 has a diameter that closely fits the outer diameter of a wheel bearing 69. Since the diameter of the aperture in the sleeve is less than the outside diameter of the original wheel bearing, a wheel bearing 69 with a smaller outside diameter than the original wheel bearing replaces the original bearing. A second length portion 108 extending from the central length portion toward the end of the bearing sleeve that is most distal of the tire sidewall has a diameter less than the outer diameter of the replacement wheel bearing. The transition from the central length portion to the second portion forms a shoulder 110 against which the outer race of the wheel bearing 69 can bear when the bearing is inserted into the bearing sleeve. A third length portion 112 extending from the central length portion to the end of the sleeve proximate the outer sidewall of the tire includes a first securing surface such as a screw thread 114 which is engageable with a complementary securing surface 116 on the cover 92 to secure the cover to the bearing sleeve.

When the outside wheel bearing is inserted into the central aperture in the bearing sleeve, the inner sidewall of the outer race of the wheel bearing bears against the shoulder 110 in the stepped diameter of the bearing sleeve's aperture. The inner 68 and outer 70 wheel bearings are clamped between a wheel nut 80 in threaded engagement with the axle and a shoulder 72 on the axle which bears on the sidewall of the inner race of the inner wheel bearing secures the wheel to the skateboard's truck.

Referring to FIGS. 4 and 5A and 5B, in an additional embodiment of the wheel cover, a bearing sleeve 120 extends through the central aperture of the tire from a point proximate the outer sidewall to a point proximate the inner sidewall. The outer diameter of the tubular bearing sleeve 120 is secured in the central aperture of a tire that has been manufactured or altered to permit the sleeve to extend between the sidewalls of the tire. The central aperture 122 of the tubular bearing sleeve includes a central length portion 124 having a diameter less than the outside diameter of the outer race of the wheel bearings. Second length portions 126 extend from the central length portion toward the ends of the bearing sleeve. The diameter of the second length portions closely fit the outside diameter of the wheel bearings 68, 70 which may be the same size and the transition between the second length portions and the central length portion comprise shoulders 128 against which the outer races of the wheel bearings may bear. A third length portion 130 extends from the second length portion to the end of the bearing sleeve that is proximate the outer sidewall of the tire. The third length portion includes a securing surface engageable by a complementary securing surface on the cover to secure the cover to the bearing sleeve.

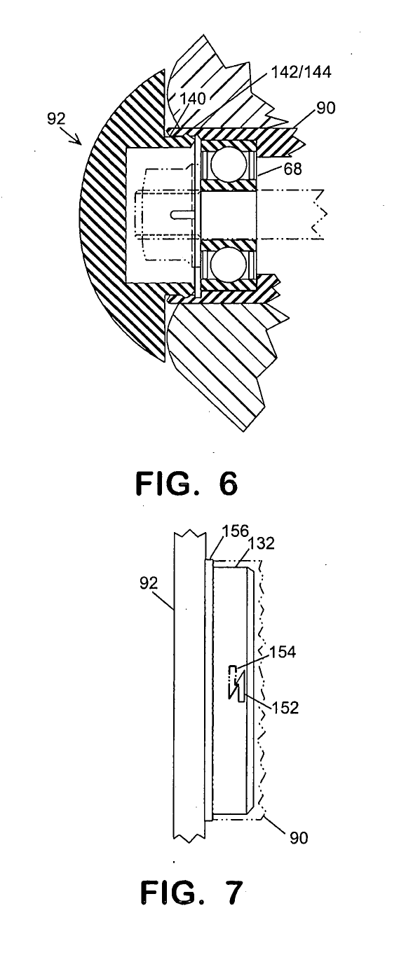

The cover 92 comprises a body 130 and an engaging portion 132 that is affixed to the body. The securing portion is arranged to engage the bearing sleeve and includes portions defining a central cavity 134 providing clearance for the wheel bearing nut 80 and the end of the axle 34. The engaging portion includes a second securing surface that is selectively engageable with the complementary first securing surface in the aperture of the bearing cup. Preferably, the securing surfaces comprise screw threads 114 on the interior wall of the bearing cup and mating screw threads 116 on the exterior surface of the engaging portion of the cover. Referring to FIG. 6, in an alternate embodiment the wall of the bearing sleeve 90 and the exterior surface of the engaging portion 140 could include complementary detent surfaces 142, 144 which interlock when the engaging portion is pressed into the bearing sleeve. Referring to FIG. 7, in an additional embodiment, the securing surfaces comprises surface 152 on the engaging portion 132 of the cover that interlocks with a surface 154 on the interior wall of the bearing sleeve 90 (shown in phantom) when the engaging portion 132 is rotated while inserted into the aperture of the bearing sleeve. A resilient washer 156 between the wheel cover and the end of the bearing sleeve permits the interlocking surfaces to be rotated past each other. When the engaging portion is engaged with bearing sleeve, the outer bearing, the end of the axle and the wheel bearing nut are hidden from view. Further, the sidewall of the wheel bearing, the cavity in the securing portion of the wheel cover and the central aperture of the bearing sleeve enclose the wheel nut and the end of the axle protecting the wheel bearing from environmental contaminants.

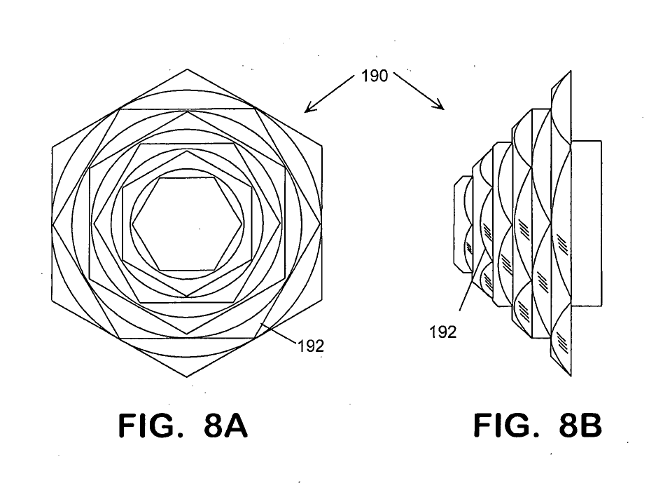

The body 130 of the wheel cover is affixed to the engaging portion and rotates with the wheel. The surface of the body distal of the tire sidewall may be shaped or otherwise decorated to enhance the cosmetic appearance of the cover. By way of examples only, the outer surface of the body 130 may have the shape of a frustrum of a cone as illustrated in FIG. 2 or a circular or elliptical segment as illustrated in FIG. 4. Referring also to FIGS. 8A and 8B, the surface of the cover 190 may also be decorated with one or more facets 192. Since the cover rotates with the tire, surface decoration of the cover's body has greater visual impact and the body can be larger than the central aperture in the tire to cover a substantial portion of the tire's sidewall and obscure unwanted decoration of the tire's sidewall. The preferred material for the cover and the bearing sleeve is metal, such as aluminum or stainless steal, but one or more of the elements could be made from a plastic or another material. A metal bearing sleeve and cover provide an excellent heat sink dissipate heat that may develop in the wheel during extended periods of use.

The inventors also concluded that the wheel cover can provide an additional surface to support the skateboard during certain maneuvers. Referring to FIG. 9, a cover 160 with a body 162 in the shape of a conical frustrum having a base proximate the outer sidewall of the tire and an apex distal of the sidewall can provide an additional surface enabling the deck the skateboard to be supported at an angle for performing unusual tricks. The angle of the deck can be adjusted by changing the diameter of the base and/or the height of the cone.

The wheel cover comprising a bearing sleeve and a cover can provide a custom cosmetic appearance, hide the hardware securing the wheel to the skateboard, protect the outside wheel bearing from contamination and provide a supporting surface useful during riding.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (We) claim:

1. A wheel cover for an annular skate board tire having portions defining a central tire aperture extending between a first sidewall and a spaced apart second sidewall, said wheel cover comprising:
(a) a sleeve insertable in said tire aperture and having a wall defining an elongate sleeve aperture including a first portion having a dimension approximating an outer dimension of a wheel bearing and a second portion including a first securing surface; and
(b) a cover comprising a mating portion engageable with said second portion of said sleeve aperture and including a second securing surface engageable with said first securing surface to selectively retain said wheel cover to said sleeve.

2. The wheel cover of claim 1 wherein a portion of said wall of said sleeve further defines a third portion of said sleeve aperture proximate an end of said sleeve distal of said second portion and having a dimension less than said dimension of said first portion.

3. The wheel cover of claim 1 wherein said first securing surface comprises a screw thread and said second securing surface defines a complementary screw thread.

4. The wheel cover of claim 1 wherein said cover further comprises a body having a dimension sufficient to obscure said central tire aperture.

5. The wheel cover of claim 4 wherein a body of said cover has a shape approximating a frustrum of a cone.

6. The wheel cover of claim 1 wherein said cover includes portions defining a cavity, an end of an axle supporting said skate board tire substantially enclosed by said cavity, said sleeve aperture and a surface of a wheel bearing when said mating portion is engaged in said sleeve aperture.

7. A wheel cover for a skateboard having an axle; a tire including a first sidewall, a second sidewall and portions defining a central aperture extending from said first sidewall toward said second sidewall; and a wheel bearing having an inner race engageable with said axle, said wheel cover comprising:
(a) a tubular bearing sleeve having an outer dimension closely fitting a diameter of said tire aperture and insertable in said tire aperture; said bearing sleeve including a first end, a second end and wall portions defining a central aperture extending from said first end to said second end, said central aperture including:
(i) a first portion extending for a length proximate said first end and having a dimension less than an outer diameter of said wheel bearing;
(ii) a second portion adjacent said first portion and having a dimension closely fitting said outer diameter of said wheel bearing; and
(iii) a third portion extending from said second portion toward said second end and including a portion defining a first securing surface; and
(b) a cover comprising:
(i) a body; and
(ii) an engaging portion engageable with said third portion of said sleeve aperture and including a second securing surface complementary with said first securing surface, engagement of said first and said second securing surfaces releasably securing said cover to said bearing sleeve.

8. The wheel cover of claim 7 wherein said body of said cover has a dimension greater than said diameter of said central aperture of said tire.

9. The wheel cover of claim 7 wherein said first securing surface comprises a screw thread and said second securing surface comprises a complement of said screw thread.

10. The wheel cover of claim 7 wherein said first securing surface comprises a first detent surface and said second securing surface comprises a complementary second detent surface engageable with said first detent surface.

11. The wheel cover of claim 7 wherein said body of said cover comprises a frustrum of a cone having a base proximate said first sidewall of said tire when said cover is secured to said bearing sleeve and an apex more distal of said first sidewall than said base.

12. The wheel cover of claim 7 wherein said body of said cover includes a first surface proximate said first sidewall of said tire when said cover is secured to said bearing sleeve and a second surface more distal of said first sidewall than said base, said second surface including a facet.

13. The wheel cover of claim 7 wherein said central aperture of said bearing sleeve includes a fourth portion adjacent said first portion and extending to a point in closer proximity to said first end than said first portion and having a dimension substantially equaling said dimension of said second portion.
